(19) United States
(12) Patent Application Publication
(10) Pub. No.: US 2024/0163767 A1
(43) Pub. Date: May 16, 2024

(54) COMMUNICATION CONTROL METHOD

(71) Applicant: KYOCERA Corporation, Kyoto (JP)

(72) Inventor: Masato FUJISHIRO, Yokohama-shi (JP)

(73) Assignee: KYOCERA Corporation, Kyoto (JP)

(21) Appl. No.: 18/416,762

(22) Filed: Jan. 18, 2024

Related U.S. Application Data
(63) Continuation of application No. PCT/JP2022/028078, filed on Jul. 19, 2022.

(30) Foreign Application Priority Data
Jul. 19, 2021 (JP) 2021-119141

(51) Int. Cl. H04W 40/02; H04L 5/00; H04W 76/15

(52) U.S. Cl. CPC H04W 40/02; H04L 5/0048; H04W 76/15

(57) ABSTRACT

A communication control method according to a first aspect includes configuring, by a network apparatus, to a first user equipment a path between the network apparatus and the first user equipment via a second user equipment, the configuring includes transmitting, by the network apparatus, a message to configure the path to the first user equipment, and the message includes information regarding an RLC channel and information regarding a radio bearer.

### RELATED APPLICATIONS

The present application is a continuation based on PCT Application No. PCT/JP2022/028078, filed on Jul. 19, 2022, which claims the benefit of Japanese Patent Application No. 2021-119141 filed on Jul. 19, 2021. The content of which is incorporated by reference herein in their entirety.

### TECHNICAL FIELD

The present invention relates to a communication control method used in a cellular communication system.

### BACKGROUND OF INVENTION

The Third Generation Partnership Project (3GPP), which is a standardization project for cellular communication systems, has prescribed packet duplication. Packet duplication is a technique in which a base station duplicates data (Packet Data Convergence Protocol-Protocol Data Unit (PDCP PDU)) and transmits the original data and the duplicated data to a user equipment.

### CITATION LIST

### Non Patent Literature

Non Patent Document 1: 3GPP TS 38.300 V16.6.0 (2021-06)

### SUMMARY

A communication control method according to a first aspect includes configuring, by a network apparatus, to a first user equipment a path between the network apparatus and the first user equipment via a second user equipment, the configuring includes transmitting, by the network apparatus, a message to configure the path to the first user equipment, and the message includes information regarding an RLC channel and information regarding a radio bearer.

A network apparatus according to a second aspect includes a processor circuitry configured to configure to a first user equipment a path between the network apparatus and the first user equipment via a second user equipment, a transmitter circuitry configured to transmit a message to configure the path to the first user apparatus, and the message includes information regarding an RLC channel and information regarding a radio bearer.

### BRIEF DESCRIPTION OF THE DRAWINGS

FIG. 1 is a diagram illustrating a configuration example of a cellular communication system according to an embodiment.

FIG. 2 is a diagram illustrating a configuration example of a user equipment (UE) according to an embodiment.

FIG. 3 is a diagram illustrating a configuration example of a base station (gNB) according to an embodiment.

FIG. 4 is a diagram illustrating a configuration example of a protocol stack for a user plane according to an embodiment.

FIG. 5 is a diagram illustrating a configuration example of a protocol stack for a control plane according to an embodiment.

FIG. 6 is a diagram illustrating an example of synchronized PDCP entities according to a first embodiment.

FIG. 7 is a diagram illustrating a first operation example according to the first embodiment.

FIG. 8 is a diagram illustrating a second operation example according to the first embodiment.

FIG. 9 is a diagram illustrating a third operation example according to the first embodiment.

FIG. 10 is a diagram illustrating a fourth operation example according to the first embodiment.

FIG. 11 is a diagram illustrating a fifth operation example according to the first embodiment.

FIG. 12 is a diagram illustrating an example of a split bearer between UEs according to the first embodiment.

FIG. 13 is a diagram illustrating a first operation example according to a second embodiment.

FIG. 14 is a diagram illustrating an example of establishment information of a split bearer between UEs according to the second embodiment.

FIG. 15 is a diagram illustrating another example of establishment information of a split bearer between UEs according to the second embodiment.

FIG. 16 is a diagram illustrating a second operation example according to the second embodiment.

FIG. 17 is a diagram illustrating a third operation example according to the second embodiment.

### DESCRIPTION OF EMBODIMENTS

The present invention aims to provide a communication control method capable of appropriately performing communication between a plurality of user equipments and a base station.

A cellular communication system according to embodiments will be described with reference to the drawings. In the description of the drawings, the same or similar parts are denoted by the same or similar reference signs.

Cellular Communication System

First, a configuration of a cellular communication system according to an embodiment will be described. Although the cellular communication system according to an embodiment is a 5G system of the 3GPP, LTE may be at least partially applied to the cellular communication system. A future cellular communication system such as the 6G may be applied to the cellular communication system.

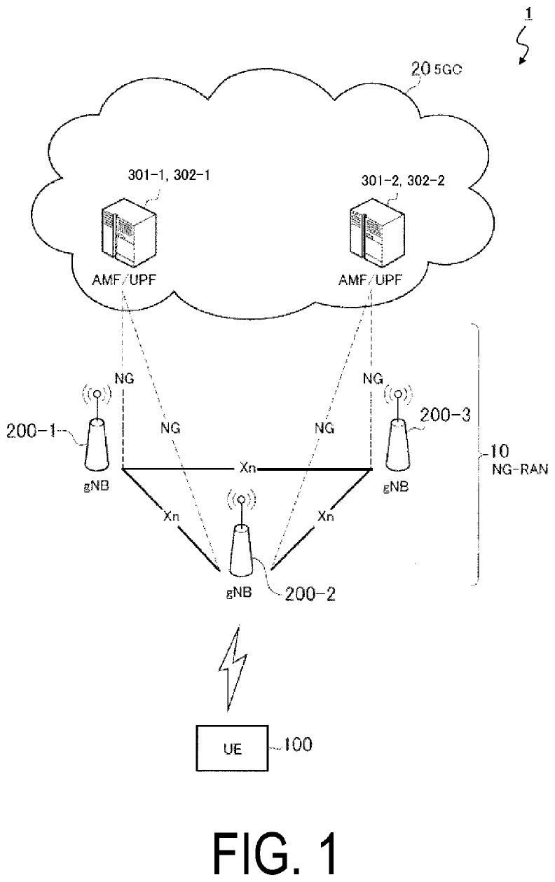

FIG. 1 is a diagram illustrating a configuration example of a cellular communication system 1 according to an embodiment.

The cellular communication system 1 includes a user equipment (UE) 100, a 5G radio access network (next generation radio access network (NG-RAN)) 10, and a 5G core network (5GC) 20 as illustrated in FIG. 1.

The UE 100 is a mobile apparatus. The UE 100 may be any apparatus as long as the apparatus is utilized by a user. Examples of the UE 100 include a mobile phone terminal (including a smartphone), a tablet terminal, a notebook PC, a communication module (including a communication card or a chipset), a sensor or an apparatus provided on a sensor, a vehicle or an apparatus provided on a vehicle (vehicle UE), or a flying object or an apparatus provided on a flying object (aerial UE).

The NG-RAN 10 includes base stations (each referred to as “gNB” in the 5G system) 200. Each of the gNBs 200 may also be referred to as an NG-RAN node. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency.

Note that the gNB may be connected to an Evolved Packet Core (EPC) which is a core network of LTE, or a base station of LTE may be connected to the 5GC 20. The base station of LTE and the gNBs may be connected via the inter-base station interface.

The 5GC 20 includes an Access and Mobility Management Function (AMF) 301 (301-1 and 301-2) and a User Plane Function (UPF) 302 (302-1 and 302-2). The AMF 301 performs various types of mobility control and the like for the UE 100. The AMF 301 communicates with the UE 100 by using Non-Access Stratum (NAS) signaling, and thereby manages information of an area in which the UE 100 exists. The UPF 302 controls data transfer. The AMF 301 and the UPF 302 are connected to the gNBs 200 via an NG interface which is an interface between the base station and the core network. The AMF 301 and the UPF 302 are examples of a core network apparatus connected to the 5GC (core network) 20.

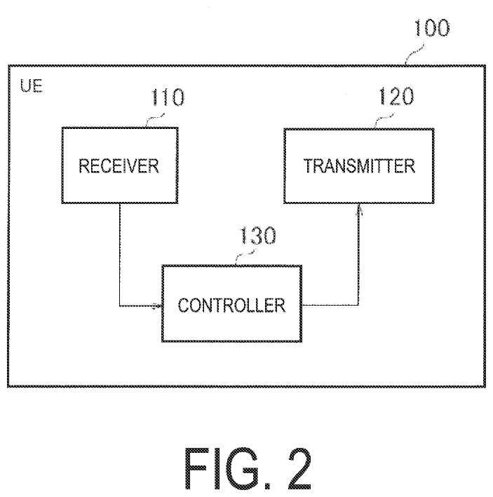

FIG. 2 is a diagram illustrating a configuration example of the user equipment (UE) 100 according to an embodiment.

The UE 100 includes a receiver 110, a transmitter 120, and a controller 130 as illustrated in FIG. 2.

The receiver 110 performs various types of reception under control of the controller 130. The receiver 110 includes an antenna and a reception device. The reception device converts (down-converts) a radio signal received through the antenna into a baseband signal (a received signal) and outputs the resulting signal to the controller 130.

The transmitter 120 performs various types of transmission under control of the controller 130. The transmitter 120 includes an antenna and a transmission device. The transmission device converts (up-converts) a baseband signal output by the controller 130 (a transmission signal) into a radio signal and transmits the resulting signal through the antenna.

The controller 130 performs various types of control in the UE 100. The controller 130 includes at least one processor and at least one memory electrically connected to the processor. The memory stores a program to be executed by the processor and information to be used for processing by the processor. The processor may include a baseband processor and a central processing unit (CPU). The baseband processor performs modulation and demodulation, coding and decoding, and the like on a baseband signal. The CPU executes the program stored in the memory to thereby perform various types of processing. The controller 130 may perform various types of processing to be performed by the UE 100 in each embodiment described below.

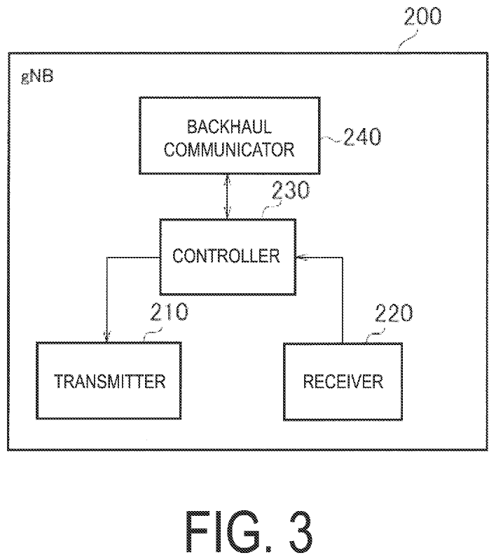

FIG. 3 is a diagram illustrating a configuration example of a base station (gNB) 200 according to an embodiment.

The gNB 200 includes a transmitter 210, a receiver 220, a controller 230, and a backhaul communicator 240 as illustrated in FIG. 3.

The transmitter 210 performs various types of transmission under control of the controller 230. The transmitter 210 includes an antenna and a transmission device. The transmission device converts (up-converts) a baseband signal output by the controller 230 (a transmission signal) into a radio signal and transmits the resulting signal through the antenna.

The receiver 220 performs various types of reception under control of the controller 230. The receiver 220 includes an antenna and a reception device. The reception device converts (down-converts) a radio signal received through the antenna into a baseband signal (a received signal) and outputs the resulting signal to the controller 230.

The controller 230 performs various types of controls for the gNB 200. The controller 230 includes at least one processor and at least one memory electrically connected to the processor. The memory stores a program to be executed by the processor and information to be used for processing by the processor. The processor may include a baseband processor and a CPU. The baseband processor performs modulation and demodulation, coding and decoding, and the like on a baseband signal. The CPU executes the program stored in the memory to thereby perform various types of processing. The controller 230 may perform various types of processing to be performed by the gNB 200 in each embodiment described below.

The backhaul communicator 240 is connected to a neighboring base station via the inter-base station interface. The backhaul communicator 240 is connected to the AMF 301 and/or the UPF 302 via an interface between a base station and the core network. Note that the gNB may include a central unit (CU) and a distributed unit (DU), and the two units may be connected via an F1 interface.

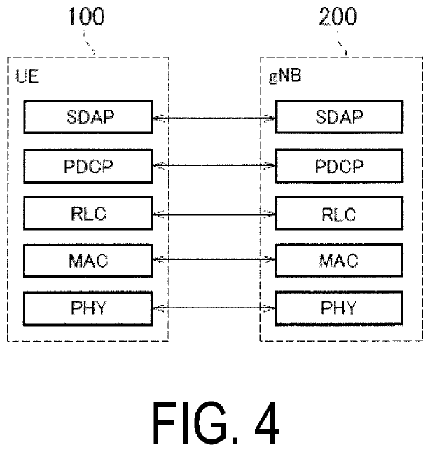

FIG. 4 is a diagram illustrating a configuration example of a radio interface protocol stack in a user plane according to an embodiment.

A radio interface protocol of the user plane that deals with data includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer as illustrated in FIG. 4.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel.

The MAC layer performs preferential control of data, retransmission processing using a hybrid ARQ (HARM), a random access procedure, and the like. Data and control information are transmitted between the MAC layer of the UE 100 and the MAC layer of the gNB 200 via a transport channel. The MAC layer of the gNB 200 includes a scheduler. The scheduler determines transport formats (transport block sizes, modulation and coding schemes (MCSs)) in the uplink and the downlink, and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression and decompression, and encryption and decryption. Data and control information are transmitted between the PDCP layer of the UE 100 and the PDCP layer of the gNB 200 via a radio bearer.

The SDAP layer maps a QoS flow being a unit in which the core network performs QoS control onto a radio bearer being a unit in which the access stratum (AS) performs QoS control. Note that, when a RAN is connected to an EPC, the SDAP need not be provided.

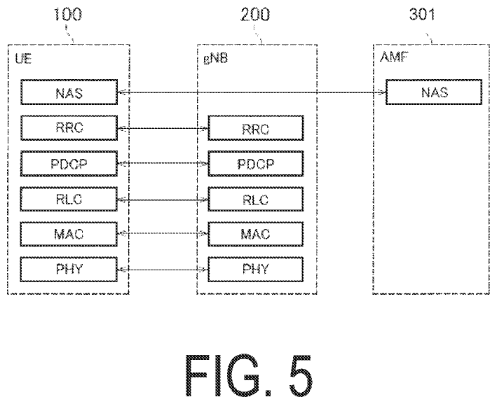

FIG. 5 is a diagram illustrating a configuration example of a radio interface protocol stack in a control plane according to an embodiment.

A radio interface protocol stack of the control plane handling signaling (control signals) includes a Radio Resource Control (RRC) layer and a NAS layer as illustrated in FIG. 5, instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When the RRC of the UE 100 is connected to the RRC of the gNB 200 (RRC connection), the UE 100 is in an RRC connected state. When the RRC of the UE 100 is not connected to the RRC of the gNB 200 (RRC connection), the UE 100 is in an RRC idle state. When an RRC connection is suspended, the UE 100 is in an RRC inactive state.

The NAS layer which is the upper layer of the RRC layer performs session management, mobility management, and the like. NAS signaling is transmitted between the NAS layer of the UE 100 and the NAS layer of the AMF 301.

Note that the UE 100 includes an application layer other than the radio interface protocol.

### First Embodiment

A first embodiment will be described.
The 3GPP has reviewed a scenario in which one user uses two UEs 100 to access one service. For example, a user may use a smartphone and a smartwatch to access one chat service, or may use two UEs 100 to access one server in a factory facility.

To be more specific, when a user uses two UEs 100, the following cases are conceivable.

A first case is that one UE 100 and the gNB 200 perform data transmission and reception and the other UE 100 and the gNB 200 do not perform data transmission and reception. This is the idea that, if one UE 100 can perform data transmission and reception, the other UE 100 may not perform data transmission and reception.

A second case is that two UEs 100 and a base station transmit and receive the same data. However, one UE 100 may be required to perform data transmission and reception and both UEs 100 may be required to perform data transmission and reception.

When a plurality of UEs 100 and a gNB 200 communicate with each other, various cases as described above can be considered. A problem, however, is how to achieve various cases described above.

In the first embodiment, the gNB 200 configures a synchronized PDCP entity for each of two UE 100-1 and 100-2. If the synchronized PDCP entity of the UE 100-1 and the synchronized PDCP entity of the UE 100-2 communicate with each other, the UE 100-1 and the UE 100-2 cooperate with each other to be able to communicate with the gNB 200.

To be specific, first, a base station (e.g., the gNB 200) configures establishment of a first synchronized PDCP entity (e.g., a synchronized PDCP entity 150-1) for a first user equipment (e.g., the UE 100-1), and configures establishment of a second synchronized PDCP entity (e.g., a synchronized PDCP entity 150-2) for a second user equipment (e.g., the UE 100-2). Second, the first user equipment establishes the first synchronized PDCP entity according to the configuration, and the second user equipment establishes the second synchronized PDCP entity according to the configuration. Third, the first synchronized PDCP entity performs communication with the second synchronized PDCP entity, and the first user equipment and the second user equipment cooperatively perform communication with the base station.

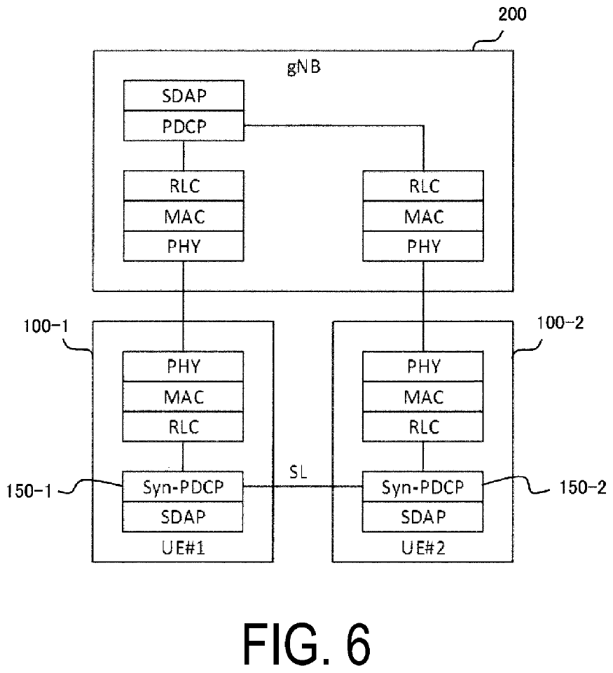

FIG. 6 is a diagram illustrating an example of synchronized PDCP entities 150-1 and 150-2 according to the first embodiment. In the example of FIG. 6, the synchronized PDCP entity (Sync-PDCP) 150-1 is established in the UE #1 (100-1), and the synchronized PDCP entity 150-2 is established in the UE #2 (100-2).

The two synchronized PDCP entities 150-1 and 150-2 may be connected in a PC5 (Sidelink (SL)) connection as illustrated in FIG. 6. The two synchronized PDCP entities 150-1 and 150-2 may communicate with each other using sidelink communication. The two synchronized PDCP entities 150-1 and 150-2 may be connected by another radio interface or by wire.

The synchronized PDCP entity 150-1 transmits, for example, a sequence number (SN) of received data (PDCP PDU) to the synchronized PDCP entity 150-2. Even if the data (PDCP PDU) is not received, the UE 100-2 assumes that the PDCP PDU has been received and performs the subsequent processing. As a result, even if the UE 100-2 does not actually receive the data, both the UE 100-1 and UE 100-2 can be assumed that the data has been received and perform processing, thereby enabling appropriate communication between the multiple UEs 100-1 and 100-2 and the gNB 200.

Information to be exchanged between the synchronized PDCP entities 150-1 and 150-2 will be described in a second operation example and subsequent operation examples below. First, a configuration of the synchronized PDCP entity will be described in a first operation example.

### First Operation Example of First Embodiment

A first operation example according to the first embodiment will be described.

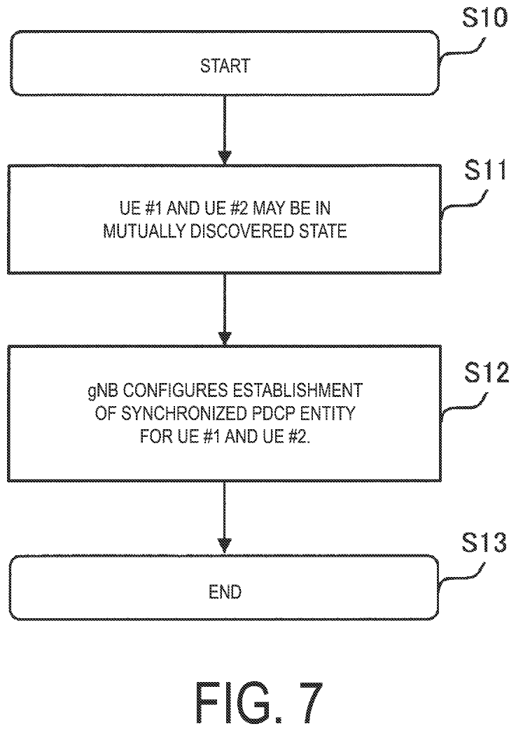

FIG. 7 is a diagram illustrating a first operation example according to the first embodiment. Note that a UE #1 indicates the UE 100-1 and a UE #2 indicates the UE 100-2.

The UE 100-1 and the UE 100-2 start processing in step S10 as illustrated in FIG. 7.

In step S11, the UE 100-1 and the UE 100-2 may be in a mutually discovered state. For example, the UE 100-1 may discover the UE 100-2 by using direct discovery of proximity based services (ProSe). For example, the UE 100-2 may also discover the UE 100-1 using direct discovery of ProSe. When the UE 100-1 and the UE 100-2 discover each other, they may be in a mutually discovered state. Alternatively, the UE 100-1 and the UE 100-2 may be paired in advance. The UEs 100 may notify the gNB 200 or the AMF 301 of the direct discovery information and/or the pairing information.

In step S12, the gNB 200 configures the UE 100-1 and the UE 100-2 to establish a synchronized PDCP entity. For example, the gNB 200 configures an RRC message including configuration information for establishing a synchronized PDCP entity to be transmitted to the UE 100-1 and the UE 100-2. The configuration information for establishing a synchronized PDCP entity may be included in “PDCP-Config” included in the RRC message. The configuration information for establishing a synchronized PDCP entity may include at least one of an indication of the synchronization type, a synchronization destination UE ID, a Quality of Service (QoS) flow ID to be synchronized, a synchronized DRB ID, and a synchronized application ID. The indication of the synchronization type, the synchronization destination UE ID, the QoS (Quality of Service) flow ID to be synchronized, and the synchronized application ID may each be associated with the DRB.

The UE 100-1 receives the configuration from the gNB 200 and establishes the synchronized PDCP entity 150-1. The UE 100-2 receives the configuration from the gNB 200 and establishes the synchronized PDCP entity 150-2. FIG. 6 is a diagram illustrating an example of the synchronized PDCP entities 150-1 and 150-2 after establishment.

Returning to FIG. 7, the gNB 200 ends the series of processing operations.

The synchronized PDCP entities 150-1 and 150-2 are established as described above according to the first operation example of the first embodiment. An operation example after the synchronized PDCP entities 150-1 and 150-2 are established will be described below. As an operation example after the synchronized PDCP entities 150-1 and 150-2 are established, first, reception of data by the UEs 100-1 and 100-2 will be described. The UEs 100-1 and 100-2 performing data transmission will be described.

(1) Case of Reception

### Second Operation Example of First Embodiment

A second operation example according to the first embodiment will be described. In the second operation example of the first embodiment, an example in which the synchronized PDCP entity 150-1 transmits a PDCP SN to the synchronized PDCP entity 150-2 when the UE 100-1 receives data but the UE 100-2 does not receive data will be described.

To be specific, first, the first user equipment (e.g., the UE 100-1) receives data from a base station. Second, the first synchronized PDCP entity (e.g., the synchronized PDCP entity 150-1) transmits the sequence number of the packet included in the data to the second synchronized PDCP entity (e.g., the synchronized PDCP entity 150-2).

Thus, even when the UE 100-2 cannot actually receive data, it is assumed that the UE has received the data, and thereby assumed that both the UE 100-1 and the UE 100-2 have received the data as described above, and the subsequent processing can be performed. Therefore, appropriate communication between the multiple UEs 100-1 and 100-2 and the gNB 200 becomes possible.

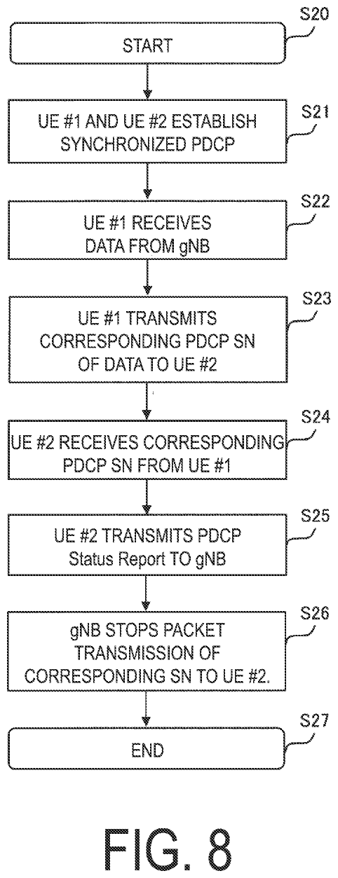

FIG. 8 is a diagram illustrating the second operation example according to the first embodiment.

The UE 100-1 and the UE 100-2 start processing in step S20 as illustrated in FIG. 8.

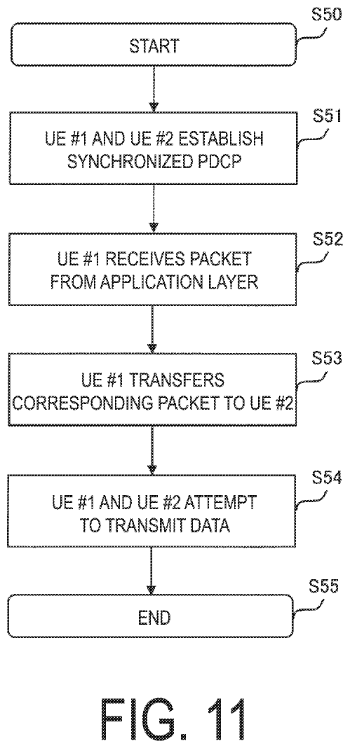

In step S21, the UE 100-1 establishes the synchronized PDCP entity 150-1 and the UE 100-2 establishes the synchronized PDCP entity 150-2. For example, as in step S12 (FIG. 11) of the first operation example, the synchronized PDCP entities 150-1 and 150-2 are established due to a configuration by the gNB 200.

In step S22, the UE 100-1 receives data from the gNB 200. The synchronized PDCP entity 150-1 of the UE 100-1 normally decodes the received data (PDCP PDU) and outputs the decoded data (PDCP SDU) to the upper layer (such as the SDAP layer).

In step S23, the UE 100-1 transmits the PDCP SN to the UE 100-2. The UE 100-1 and the UE 100-2 are connected via a PC5 interface. In this case, the synchronized PDCP entity 150-1 of the UE 100-1 may transmit the PDCP SN to the synchronized PDCP entity 150-2 of the UE 100-2 by using a PC5-RRC message or a PC5-S message of the PC5 interface. The UE 100-1 and the UE 100-2 may be connected by wire. The UE 100-1 may transmit the PDCP SN to the UE 100-2 via an application.

In step S24, the UE 100-2 receives, from the UE 100-1, the PDCP SN transmitted from the UE 100-1. The synchronized PDCP entity 150-2 receives the PDCP SN.

First, the reception of the PDCP SN makes the UE 100-2 to assume that it has received the data even though the UE 100-2 has not actually received the data from the gNB 200. Alternatively, the UE 100-2 may assume that it has received even the PDCP of the corresponding sequence number due to the reception of the PDCP SN. The synchronized PDCP entity 150-1 may move the reception window (RX DELIV) to the sequence number. Note that the reception window (RX DELIV) represents the count value of pending PDCP SDUs that have not been delivered to the upper layer.

Second, the UE 100-2 may notify the lower layer (RLC/MAC/PHY) of the fact that the data has been received. The synchronized PDCP entity 150-2 may perform such notification to the lower layer. The synchronized PDCP entity 150-2 may instruct the lower layer to discard the currently received packet. The synchronized PDCP entity 150-2 may instruct the lower layer to immediately hand over the currently received packet to the upper layer. When the RLC entity of the UE 100-2 performs a retransmission process, the reception of the notification from the synchronized PDCP entity 150-2 may cancel transmission of a NACK.

In step S25, in response to the reception of the PDCP SN from the UE 100-1, the UE 100-2 transmits a PDCP Status Report to the gNB 200. For example, the synchronized PDCP entity 150-2 transmits the PDCP Status Report to the gNB 200. The PDCP Status Report indicates that the data (PDCP PDU) up to data having the sequence number has been normally received. Note that the UE 100-2 may transmit another report (or message) instead of the PDCP Status Report.

In step S26, in response to the reception of the PDCP Status Report from the UE 100-2, the gNB 200 stops transmission of data (PDCP) having the sequence number to the UE 100-2. Upon reception of the PDCP Status Report, the gNB 200 recognizes that the UE 100-2 has normally received the data, and stops transmission of the data (PDCP) having the sequence number. When the gNB 200 is performing retransmission process with respect to the UE 100-2, the gNB 200 stops retransmission of the data having the sequence number with respect to the UE 100-2.

In step S27, the gNB 200 ends the series of processing operations.

### Third Operation Example of First Embodiment

A third operation example according to the first embodiment will be described. The third operation example of the first embodiment is an example in which, when the UE 100-1 receives data from the gNB 200, the synchronized PDCP entity 150-1 transmits the received data (PDCP SDU) to the synchronized PDCP entity 150-2.

To be specific, the first user equipment (e.g., the UE 100-1) receives data from the base station (e.g., the gNB 200). Second, the first synchronized PDCP entity (e.g., the synchronized PDCP entity 150-1) transfers the packet included in the data (e.g., PDCP SDU) to the second synchronized PDCP entity (e.g., the synchronized PDCP entity 150-2).

For this reason, even when the UE 100-1 has received data transmitted from the gNB 200 but the UE 100-2 failed to receive the data, for example, the UE 100-2 can appropriately receive the data because the UE 100-1 transfers the data. Even when both the UE 100-1 and the UE 100-2 receive data transmitted from the gNB 200, for example, the UE 100-2 can appropriately receive the data because the UE 100-1 transfers the data, which improves the reception accuracy of the UE 100-2.

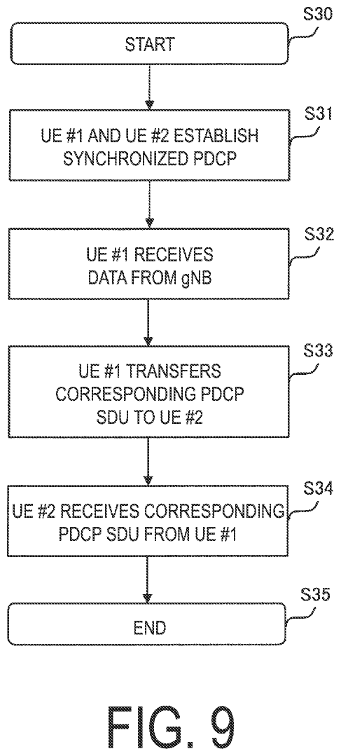

FIG. 9 is a diagram illustrating the third operation example according to the first embodiment. FIG. 9 can also be applied to both the UE 100-1 and the UE 100-2 receiving data. FIG. 9 is also applicable to the UE 100-1 receiving the data and the UE 100-2 not receiving the data.

The UE 100-1 and the UE 100-2 start processing in step S30 as illustrated in FIG. 9.

In step S31, the UE 100-1 establishes the synchronized PDCP entity 150-1 and the UE 100-2 establishes the synchronized PDCP entity 150-2. For example, a configuration by the gNB 200 may establish the synchronized PDCP entities as in step S12 (FIG. 11) of the first operation example.

In step S32, the UE 100-1 receives data from the gNB 200. The synchronized PDCP entity 150-1 of the UE 100-1 normally decodes the packet (PDCP PDU) included in the received data by decrypting the encrypted PDCP SDU. The synchronized PDCP entity 150-1 outputs the decoded packet (PDCP SDU) to the upper layer of the UE 100-1.

In step S33, the UE 100-1 transfers the packet (PDCP SDU) included in the data to the UE 100-2. For example, the synchronized PDCP entity 150-1 transfers the PDCP SDU to the synchronized PDCP entity 150-2. The synchronized PDCP entity 150-1 may transmit the SN of the PDCP SDU to the synchronized PDCP entity 150-2.

In step S34, the UE 100-2 receives the data (PDCP SDU) transmitted from the UE 100-1. The UE 100-2 is assumed to have received the data even when it has not actually received the data from the gNB 200. When the UE 100-2 has received the PDCP SN from the UE 100-1, the UE 100-2 may be assumed to have received the data of the sequence number (PDCP PDU) indicated by the PDCP SN.

Note that, when the synchronized PDCP entity 150-2 of the UE 100-2 receives the data transmitted from the gNB 200 and is able to normally decode the data, the synchronized PDCP entity may transfer the received data (PDCP SDU) to the synchronized PDCP entity 150-1 of the UE 100-1.

In step S35, the UE 100-1 and the UE 100-2 ends the series of processing operations.

(2) Case of Transmission

### Fourth Operation Example of First Embodiment

A fourth operation example according to the first embodiment will be described. The fourth operation example of the first embodiment and a fifth operation example of the first embodiment in the following stage are examples of data transmission from the UE 100-1 and the UE 100-2.

The fourth operation example of the first embodiment is an example in which the UE 100-1 transmits the sequence number of a packet included in data to the UE 100-2 when the UE 100-1 has normally transmitted the data to the gNB 200.

To be specific, first, the first user equipment (e.g., the UE 100-1) transmits data to the base station (e.g., the gNB 200). Second, the first synchronized PDCP entity (e.g., the synchronized PDCP entity 150-1) transmits the sequence number of the packet included in the data to the second synchronized PDCP entity (e.g., the synchronized PDCP entity 150-2).

Thus, for example, when the UE 100-1 and the UE 100-2 transmit the same data to the gNB 200, the UE 100-1 transmits the sequence number to the UE 100-2, and the UE 100-2 can stop the data transmission by assuming that the data transmission has been completed. Therefore, the UE 100-1 and the UE 100-2 can appropriately transmit the data to the gNB 200. The UE 100-1 and the UE 100-2 can also reduce redundancy by stopping transmission of the same data.

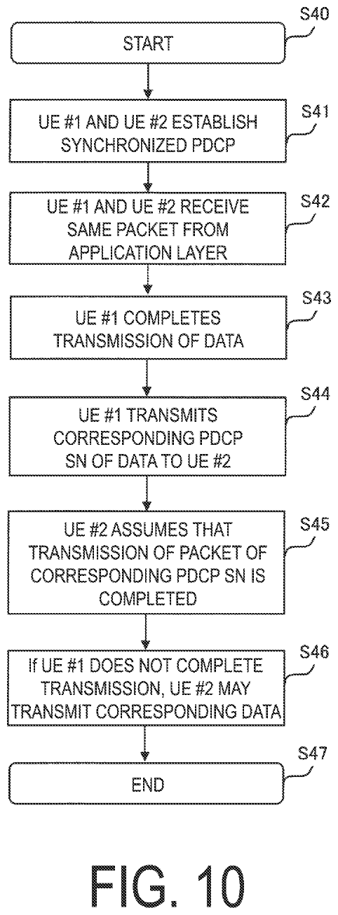

FIG. 10 is a diagram illustrating the fourth operation example according to the first embodiment.

Note that the fourth operation example is also applicable to the UE 100-1 transmitting data and the UE 100-2 not transmitting data. The fourth operation example is also applicable to both the UE 100-1 and the UE 100-2 transmitting data.

It is assumed in the fourth operation example that the synchronized PDCP entities 150-1 and 150-2 are both connected to the same application layer, and the UE 100-1 and the UE 100-2 transmit the same data.

The UE 100-1 and the UE 100-2 start processing in step S40 as illustrated in FIG. 10.

In step S41 the UE 100-1 establishes the synchronized PDCP entity 150-1 and the UE 100-2 establishes the synchronized PDCP entity 150-2.

In step S42, the UE 100-1 and the UE 100-2 receive the same packet from the application layer. For example, the synchronized PDCP entity 150-1 of the UE 100-1 and the synchronized PDCP entity 150-2 of the UE 100-2 receive the same packet from the application layer.

Here, the UE 100-1 and the UE 100-2 attempt to transmit data including the packet. It is assumed that the transmission of the data is delayed due to retransmission of the packet by the UE 100-2. Alternatively, the UE 100-1 may be assumed to transmit the data and the UE 100-2 may be assumed not to transmit the data. The gNB 200 may configure one UE 100 out of the UE 100-1 and the UE 100-2 that is supposed to attempt to transmit data first. This configuration may be performed by using an RRC message, a PDCP Control PDU, a MAC Control Element (CE), Downlink Control Information (DCI), or the like.

In step S43, the UE 100-1 completes transmission of the data. For example, in retransmission control in a lower layer (RLC or MAC), the synchronized PDCP entity 150-1 may confirm completion of transmission of data including the packet by receiving confirmation about ACK reception from the lower layer.

In step S44, the UE 100-1 transmits the PDCP SN of the packet to the UE 100-2. For example, the synchronized PDCP entity 150-1 transmits the PDCP SN to the synchronized PDCP entity 150-2 of the UE 100-2. As in the second operation example (step S23 in FIG. 8), the synchronized PDCP entity 150-1 may transmit the PDCP SN using an PC5-RRC message, an PC5-S message, or the like.

In step S45, the UE 100-2 assumes that transmission of the packet has been completed. The UE 100-2 may assume that transmission of packets (PDCP PDUs) up to the PDCP SN has been completed. For example, in response to the reception of the PDCP SN, the synchronized PDCP entity 150-2 of the UE 100-2 may assume that transmission of the packet has been completed even when transmission of the packet is not completed or when the packet is not transmitted. Note that the upper layer (the RRC entity or the synchronized PDCP entity 150-2) of the UE 100-2 may notify the lower layer of completed transmission of the packet. In this case, the synchronized PDCP entity 150-2 may discard the packet received from the application layer. In this case, the lower layer (the RLC entity or the MAC entity) of the UE 100-2 may discard the packet upon receiving the completed transmission.

In step S46, when the transmission of the packet is not completed (or when the transmission of the packet is delayed due to a retransmission process), the UE 100-1 may transmit the PDCP SN of the packet whose transmission is not completed to the UE 100-2. In this case, in response to the reception of the PDCP SN, the UE 100-2 may attempt to transmit the packet whose transmission is not completed by the UE 100-1 to the gNB 200. As a result, for example, when transmission by the UE 100-1 is not completed in the case in which the UE 100-1 performs transmission but the UE 100-2 does not perform transmission, the UE 100-2 may be used to transmit data whose transmission has not been completed.

In step S47, the UE 100-1 and the UE 100-2 end the series of processing operations.

### Fifth Operation Example of First Embodiment

A fifth operation example according to the first embodiment will be described. The fifth operation example of the first embodiment is an example in which the UE 100-1 and the UE 100-2 transmit the same data to the gNB 200. Specifically, first, the first synchronized PDCP entity (e.g., the synchronized PDCP entity 150-1) transmits data to the second synchronized PDCP entity (e.g., the synchronized PDCP entity 150-2). Second, the first user equipment (e.g., the UE 100-1) and the second user equipment (e.g., the UE 100-2) transmit the data to the base station (e.g., the gNB 200).

Thus, for example, the UE 100-1 and the UE 100-2 can appropriately transmit the same data to the gNB 200. The reliability in data transmission from the UEs 100-1 and 100-2 can be improved.

FIG. 11 is a diagram illustrating the fifth operation example according to the first embodiment. The fifth operation example of the first embodiment is applicable to the UE 100-1 and the UE 100-2 performing transmission. The fifth operation example is also applicable to the UE 100-1 performing transmission and the UE 100-2 not performing transmission. However, in the fifth operation example, the UE 100-1 and the UE 100-2 are assumed to receive data (packets) from different application layers.

The UE 100-1 and the UE 100-2 start processing in step S50 as illustrated in FIG. 11.

In step S51, the UE 100-1 establishes the synchronized PDCP entity 150-1, and the UE 100-2 establishes the synchronized PDCP entity 150-2.

In step S52, the UE 100-1 receives a packet from an application layer.

In step S53, the UE 100-1 transfers the packet (PDCP SDU) to the UE 100-2. For example, the synchronized PDCP entity 150-1 duplicates the packet received from the application layer and transmits the duplicated packet to the synchronized PDCP entity 150-2 of the UE 100-2. The synchronized PDCP entity 150-1 may transmit the packet through sidelink communication.

In step S54, the UE 100-1 and the UE 100-2 attempts to transmit the packet. The UE 100-1 and the UE 100-2 transmit the same data (packet).

In step S55, the UE 100-1 and the UE 100-2 ends the series of processing operations.

### Second Embodiment

A second embodiment will be described.

In the first embodiment, an example in which the synchronized PDCP entities 150-1 and 150-2 are used to enable the two UEs 100-1 and 100-2 to receive data and the two UEs 100-1 and 100-2 to transmit data has been described.

The second embodiment introduces an example in which an inter-UE split bearer is established for the two UEs 100-1 and 100-2. The UEs 100-1 and 100-2 perform data transmission and reception with respect to the gNB 200 by using the inter-UE split bearer.

To be specific, first, a base station (e.g., the gNB 200) establishes a split bearer between a first user equipment (e.g., the UE 100-1) and a second user equipment (e.g., the UE 100-2) for the first user equipment and the second user equipment. Second, according to the establishment, the first user equipment communicates with the base station by using a first path (e.g., a first radio bearer) between the first user equipment and the base station, and communicates with the base station by using a second path (e.g., a second radio bearer) between the second user equipment and the base station.

Since the UEs 100-1 and 100-2 perform data transmission and reception with respect to the gNB 200 by using the first path and the second path established with the inter-UE split bearer as described above in the second embodiment, the UEs 100-1 and 100-2 and the gNB 200 can appropriately perform communication. Efficient communication can also be realized.

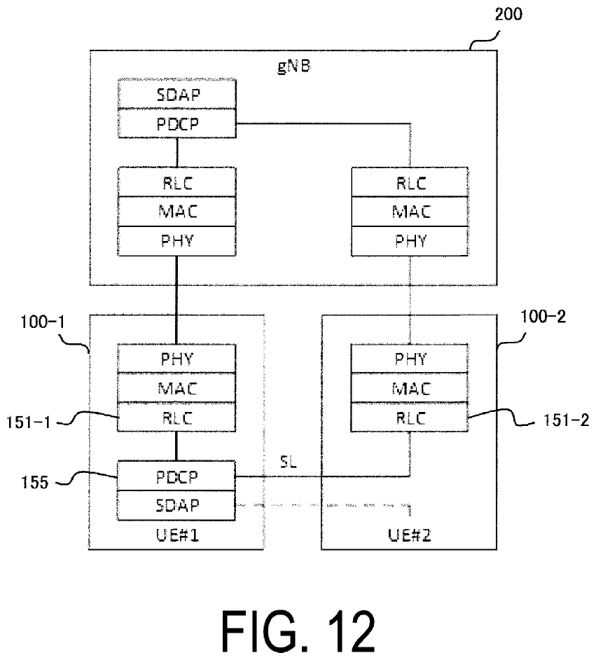

FIG. 12 is a diagram illustrating an example of the inter-UE split bearer according to the first embodiment. As illustrated in FIG. 12, a PDCP entity 155 of the UE 100-1 is associated with an RLC entity 151-1 of the UE 100-1 and is associated with an RLC entity 151-2 of the UE 100-2. In this case, the UE 100-1 may be the master UE and the UE 100-2 may be the secondary UE. The inter-UE split bearer includes the first radio bearer between the UE 100-1 including the RLC entity 151-1 and the gNB 200 and the second radio bearer between the UE 100-2 including the RLC entity 151-2 and the gNB 200. The UE 100-1 can communicate with the gNB 200 by using the first radio bearer. The UE 100-1 can communicate with the gNB 200 by using the second radio bearer via the UE 100-2.

Here, the UE 100-1 and the UE 100-2 may be in PC5 (sidelink (SL)) connection as in the first embodiment. The UE 100-1 and the UE 100-2 may communicate with each other using sidelink communication, as in the first embodiment. The UE 100-1 and the UE 100-2 may be connected by another radio interface or may be connected by wire, as in the first embodiment.

The UE 100-2 may be connected to an application layer. In this case, when the UE 100-2 receives a packet from the application layer, the UE 100-2 transmits the packet to the SDAP entity or the PDCP entity 155 of the UE 100-1. The SDAP entity maps the radio bearer to the QoS flow for the packet, and the PDCP entity 155 performs processing such as encryption for the packet (PDCP SDU).

The PDCP entity 155 can transmit the processed packet to the RLC entity 151-2 of the UE 100-2 by using the inter-UE split bearer. As a result, for example, the data on the UE 100-2 side can be subjected to processing such as encryption on the UE 100-1 side, and the processed data can be transmitted from the UE 100-2.

Hereinafter, first, an operation example (a first operation example) related to establishment of the inter-UE split bearer will be described. An operation example (a second operation example) of UL transmission after establishment of the inter-UE split bearer will be described. Finally, an operation example (a third operation example) of DL transmission after establishment of the inter-UE split bearer will be described.

### First Operation Example of Second Embodiment

A first operation example according to the second embodiment will be described. The first operation example of the second embodiment represents an establishment example in which an inter-UE split bearer is established for the UE 100-1 and the UE 100-2.

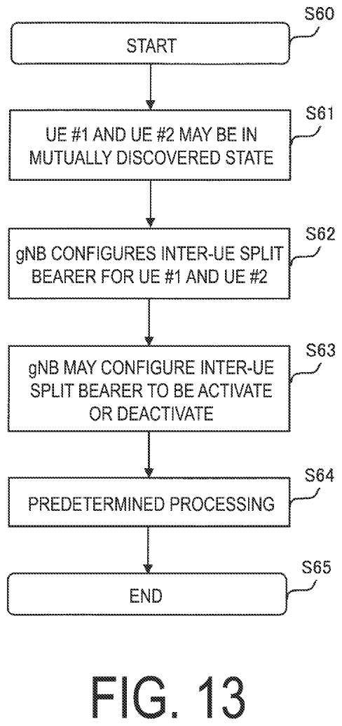

FIG. 13 is a diagram illustrating the first operation example according to the second embodiment.

The UE 100-1 and the UE 100-2 start processing in step S60 as illustrated in FIG. 13.

In step S61, the UE 100-1 and the UE 100-2 may be in a mutually discovered state. As in the first embodiment (step S11 in FIG. 7), the UE 100-1 and the UE 100-2 may use the discovery function to discover each other, thereby entering the discovered state.

In step S62, the gNB 200 establishes an inter-UE split bearer for the UE 100-1 and the UE 100-2. The gNB 200 may set the establishment by transmitting a message including establishment information of the inter-UE split bearer to the UE 100-1 and the UE 100-2.

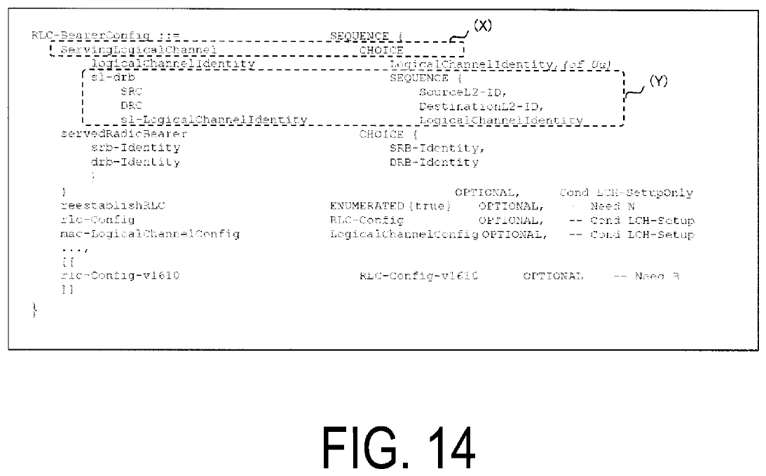

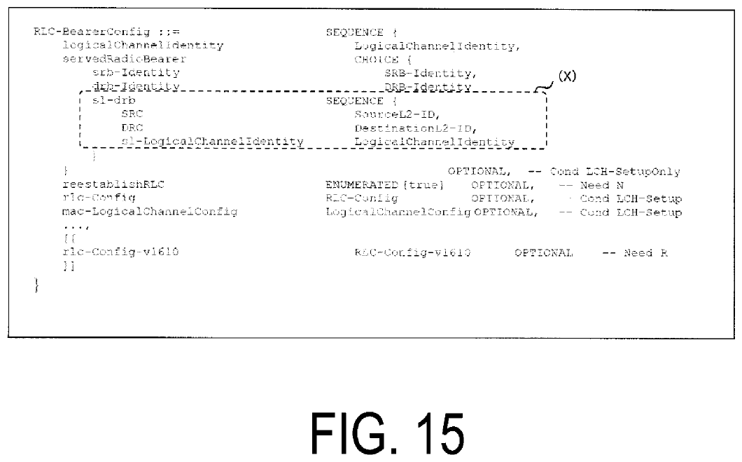

First, the establishment information of the inter-UE split bearer may be, for example, as follows. FIG. 14 and FIG. 15 are diagrams illustrating examples of establishment information of an inter-UE split bearer according to the second embodiment. Among the diagrams, FIG. 14 illustrates an example of the configuration information configured by the gNB 200 for the UE 100-1.

In FIG. 14, an example in which “RLC-BearerConfig” is used as the establishment information is illustrated. The dashed line (X) (“Serving LogicalChannel”) in FIG. 14 represents an RLC channel (RLC bearer and MAC LCH) of the UE 100-1. The dashed line (Y) in FIG. 14 represents information about a radio bearer of sidelink communication associated with the RLC channel. (“ServedRadioBearer”) below the dashed line (Y) in FIG. 14 includes information about the DRB (the PDCP entity 155) associated with the RLC channel.

That is, the establishment information configured for the UE 100-1 indicates that the DRB (the PDCP entity 155), the DRB of sidelink communication, and the RLC channel of the UE 100-1 are associated with each other and the inter-UE split bearer is established due to the association.

On the other hand, FIG. 15 illustrates an example of the establishment information configured by the gNB 200 for the UE 100-2. In FIG. 15, an example in which “RLC-BearerConfig” is used as the establishment information is illustrated as well. FIG. 15 includes “LogicalChannelIdentity” and “serverRadioBearer”. “LogicalChannelIdentity” represents the RLC channel (RLC bearer and MAC LCH) of the UE 100-2. “serverRadioBearer” represents information about the bearer associated with the RLC channel. The information about the bearer associated with the RLC channel includes “drb-identity” and a radio bearer (“sl-drb”) (dashed line (X)) of sidelink communication. “Drb-identity” represents the ID of the DRB (the PDCP entity 155) of the UE 100-1.

That is, the establishment information configured to the UE 100-2 represents that the RLC channel of the UE 100-2, the DRB (the PDCP entity 155) of the UE 100-1, and the DRB of sidelink communication between the UE 100-1 and the UE 100-2 are associated and the inter-UE split bearer is established due to the association.

Second, the establishment information of the inter-UE split bearer may include the following. That is, the establishment information of the inter-UE split bearer may include information indicating which UE is the master and which UE is the secondary. For example, the establishment information illustrated in FIG. 14 may include information indicating that the UE 100-1 is the master UE, and the establishment information illustrated in FIG. 15 may include information indicating that the UE 100-2 is the secondary UE.

The establishment information for establishing the inter-UE split bearer may include information indicating which UE (or which link) is set as primary in UL transmission. Information indicating which UE (or which link) is set as secondary may be included.

The establishment information for establishing the inter-UE split bearer may include information indicating whether duplication (or simultaneous transmission) is to be performed.

Returning to FIG. 13, in step S63, the gNB 200 may configure to activate or deactivate the inter-UE split bearer. This configuration may be performed by using an RRC message, MAC CE, or DCI. The configuration may be activation or deactivation of an SL DRB. In this case, the inter-UE split bearer may be activated (or turned on) by activating the SL DRB. The inter-UE split bearer may be deactivated (or turned off) by deactivating the SL DRB. Note that, when SL-Radio Link Failure (RLF) occurs in PC5 connection or when PC-5RRC connection is released between the UE 100-1 and the UE 100-2, the inter-UE split bearer may be (automatically) deactivated. Alternatively, in this case, the establishment of the inter-UE split bearer may be (automatically) de-configured.

In step S64, when the inter-UE split bearer is in the activated state, the UEs 100-1 and 100-2 and the gNB 200 perform predetermined processing. The predetermined processing is UL transmission or DL transmission. The UL transmission will be described in the second operation example of the second embodiment, and the DL transmission will be described in the third operation example of the second embodiment.

In step S65, the UE 100-1, the UE 100-2, and gNB 20 end the series of processing operations.

### Second Operation Example of Second Embodiment

A second operation example according to the second embodiment will be described. The second operation example of the second embodiment is an example in which UL transmission is performed when the inter-UE split bearer is active.

To be specific, the PDCP entity of the first user equipment (e.g., the PDCP entity 155 of the UE 100-1) transmits data to a base station (e.g., the gNB 200) by using a first path (e.g., a first radio bearer). The PDCP entity of the first user equipment transmits data to the base station by using a second path (e.g., a second radio bearer).

Since the UE 100-1 can perform data transmission to the gNB 200 by using the first radio bearer and the second radio bearer as described above, the UE can appropriately perform UL transmission.

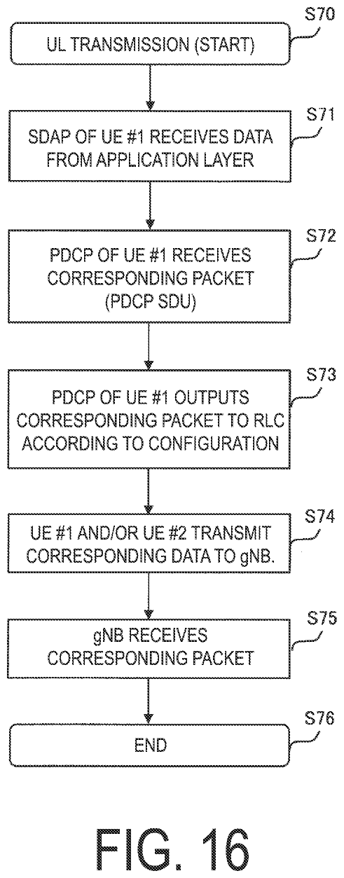

FIG. 16 is a diagram illustrating the second operation example according to the second embodiment.

As illustrated in FIG. 16, the UE 100-1 starts UL transmission in step S70.

In step S71, an SDAP entity of the UE 100-1 receives a packet (SDAP SDU) from an application layer. The SDAP entity of the UE 100-1 may receive a packet (SDAP SDU) from the UE 100-2.

In step S72, the PDCP entity 155 of the UE 100-1 receives the packet (PDCP SDU) from the SDAP entity. The PDCP entity 155 may perform processing such as security, header compression, and header addition on the packet.

In step S73, the PDCP entity 155 of the UE 100-1 outputs the packet to one of the RLC entity 151-1 of the UE 100-1 and the RLC entity 151-2 of the UE 100-2 in accordance with the establishment of the inter-UE split bearer (step S62 in FIG. 13).

First, when duplication is configured, the PDCP entity 155 outputs the packet to both the RLC entities 151-1 and 151-2.

Second, when the single transmission is configured, the PDCP entity 155 outputs the packet to one of the RLC entity 151-1 and the RLC entity 151-2 according to the establishment of the inter-UE split bearer.

Note that the PDCP entity 155 performs transmission to the RLC entity 151-2 of the UE 100-2 by mapping the packet to the SL DRB according to the establishment. The RLC entity 151-2 receives the packet through the SL DRB.

In step S74, the UE 100-1 and/or the UE 100-2 transmit data including the packet to the gNB 200. The UE 100-1 uses the first radio bearer to transmit the data to the gNB 200. The UE 100-1 uses the second radio bearer to transmit the data to the gNB 200 via the UE 100-2.

In step S75, the gNB 200 receives the data. The PDCP entity of the gNB 200 may perform processing of discharging, sequence control, or the like on duplicate packets.

In step S76, the gNB 200 ends the series of processing operations.

### Third Operation Example of Second Embodiment

A third operation example according to the second embodiment will be described. The third operation example of the second embodiment is an example in which DL transmission is performed when the inter-UE split bearer is active.

To be specific, the PDCP entity of the first user equipment (e.g., the PDCP entity 155 of the UE 100-1) receives the data transmitted from the base station (e.g., the gNB 200) by using the first path (e.g., the first radio bearer), and receives the data transmitted from the base station by using the second path (e.g., the second radio bearer).

As a result, since the UE 100-1 can receive the data transmitted from the gNB 200 via the first radio bearer and the second radio bearer, DL transmission can be appropriately performed.

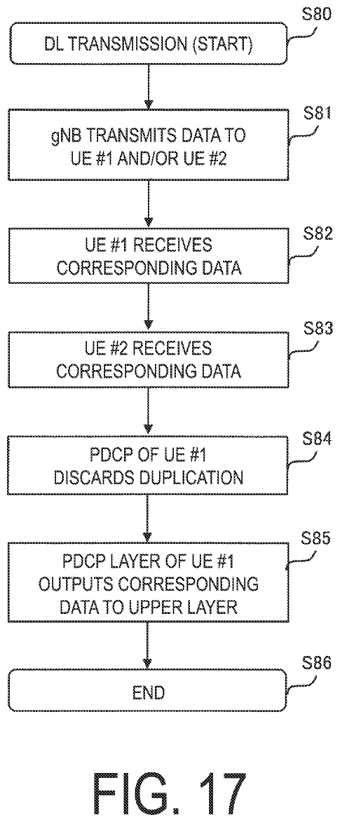

FIG. 17 is a diagram illustrating the third operation example according to the second embodiment.

As illustrated in FIG. 17, the gNB 200 starts DL transmission in step S80.

In step S81, the gNB 200 transmits data to the UE 100-1 and/or the UE 100-2. The gNB 200 may duplicate the data (PDCP PDU) and transmit the original data to the UE 100-1 and transmit the duplicated data to the UE 100-2.

In step S82, the UE 100-1 receives the data from the gNB 200. The RLC entity 151-1 of the UE 100-1 outputs the packet (PDCP PDU) included in the data to the PDCP entity 155.

In step S83, the UE 100-2 receives the data transmitted from the gNB 200. The RLC entity 151-2 of the UE 100-2 maps the packet (PDCP PDU) included in the data to the SL DRB according to the establishment of the inter-UE split bearer. The PDCP entity 155 of the UE 100-1 receives the packet through the SL DRB.

In step S84, the PDCP entity 155 of the UE 100-1 discards the duplicate. The PDCP entity 155 may discard any one of the packet received from the RLC entity 151-1 and the packet received from the RLC entity 151-2. The PDCP entity 155 may perform sequence control. The PDCP entity 155 may also perform processing performed in the PDCP entity, such as security, header compression, and header addition.

In step S85, the PDCP entity 155 of the UE 100-1 outputs the processed packet (PDCP SDU) to the upper layer.

In step S86, the UE 100-1 ends the series of processing operations.

### Other Embodiments

A program causing a computer to execute each of the processes performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM.

Circuits for executing the processes to be performed by the UE 100 or the gNB 200 may be integrated, and at least part of the UE 100 or the gNB 200 may be configured as a semiconductor integrated circuit (a chipset or an SoC).

The phrases “based on” and “depending on” used in the present disclosure do not mean “based only on” and “only depending on”, unless specifically stated otherwise. The phrase “based on” means both “based only on” and “based at least in part on”. The phrase “depending on” means both “only depending on” and “at least partially depending on”. “Obtain” or “acquire” may mean to obtain information from stored information, may mean to obtain information from information received from another node, or may mean to obtain information by generating the information. The terms “include”, “comprise” and variations thereof do not mean “include only items stated” but instead mean “may include only items stated” or “may include not only the items stated but also other items”. In addition, the term “or” used in the present disclosure is not intended to be “exclusive or”. Any references to elements using designations such as “first” and “second” as used in the present disclosure do not generally limit the quantity or order of those elements. These designations may be used in the present description as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

Although embodiments have been described in detail with reference to the drawings, a specific configuration is not limited to those described above, and various design modifications and the like can be made without departing from the scope of the present disclosure. All of or a part of the embodiments can be combined together as long as no inconsistencies are introduced.

### REFERENCE SIGNS

1 Mobile communication system
10 5GC
100 (100-1 and 100-2) UE
110 Receiver
120 Transmitter
150-1, 150-2 Synchronized PDCP entity
151-1 RLC entity
151-2 RLC entity
155 PDCP entity
200 (200-1 to 200-3) gNB
210 Transmitter
220 Receiver
230 Controller
301 AMF
302 UPF

1. A communication control method, comprising:
configuring, by a network apparatus, to a first user equipment a path between the network apparatus and the first user equipment via a second user equipment wherein
the configuring includes transmitting, by the network apparatus, a message to configure the path to the first user equipment, and
the message includes information regarding an RLC channel and information regarding a radio bearer.

2. A network apparatus, comprising:
a processor circuitry configured to configure to a first user equipment a path between the network apparatus and the first user equipment via a second user equipment; and
a transmitter circuitry configured to transmit a message to configure the path to the first user apparatus, wherein
the message includes information regarding an RLC channel and information regarding a radio bearer.

3. A cellular communication system, comprising:
a first user equipment and a second user equipment; and
a network apparatus, wherein
the network apparatus configures to the first user equipment a path between the network apparatus and the first user equipment via the second user equipment, and transmits a message to configure the path to the first user equipment, and
the message includes information regarding an RLC channel and information regarding a radio bearer.

4. A non-transitory computer-readable storage medium storing a program for causing computer to execute processing comprising:
configuring to a first user equipment a path between the network apparatus and the first user equipment via a second user equipment, wherein
the configuring includes transmitting a message to configure the path to the first user equipment, and
the message includes information regarding an RLC channel and information a radio bearer.

5. A chipset for a network apparatus, the chipset comprising:
configuring to a first user equipment a path between the network apparatus and the first user equipment via a second user equipment, wherein
the configuring includes transmitting a message to configure the path to the first user equipment, and
the message includes information regarding an RLC channel and information a radio bearer.
